(19) United States
(12) Patent Application Publication
(10) Pub. No.: US 2026/0357971 A1
(43) Pub. Date: Nov. 12, 2026

(54) EXTENSION CLIP IN COLLAR FOR FRAMES AND/OR FOR RECESSED LIGHT FIXTURES

(71) Applicant: AMP Plus, Inc., Vernon, CA (US)

(72) Inventor: Brandon Cohen, Vernon, CA (US)

(73) Assignee: AMP Plus, Inc., Vernon, CA (US)

(21) Appl. No.: 19/412,218

(22) Filed: Dec. 8, 2025

Related U.S. Application Data
(63) Continuation-in-part of application No. 19/057,375, filed on Feb. 19, 2025, now Pat. No. 12,674,572.
(63) Continuation-in-part of application No. 19/020,672, filed on Jan. 14, 2025, now Pat. No. 12,723,747.
(63) Continuation-in-part of application No. 29/894,010, filed on Jun. 5, 2023, now Pat. No. D1108685.
(63) Continuation-in-part of application No. 29/962,228, filed on Sep. 10, 2024, now Pat. No. D1108686.
(63) Continuation-in-part of application No. 29/981,337, filed on Dec. 30, 2024, now Pat. No. D1108687.
(63) Continuation-in-part of application No. 19/005,849, filed on Dec. 30, 2024.
(63) Continuation-in-part of application No. 18/597,114, filed on Mar. 6, 2024, now Pat. No. 12,734,592.

(51) Int. Cl. F21V 21/04

(52) U.S. Cl. CPC F21V 21/044; F21V 21/049

(57) ABSTRACT

An extension-collar is configured to be clipped onto a descending sleeve-structure of a lighting-frame, in order to effectively extend a height of sleeve-structure downwards, to accommodate a thick ceiling that may be thicker than a typical drywall ceiling. This extension-collar may be attached to the sleeve-structure without use of separate tools. Such a lighting-frame is typically installed above a given ceiling, in between joists, and receives a lighting-module. The extension-collar may have a top-cylindrical-portion and a bottom-cylindrical-portion; and extending upwards from the bottom-cylindrical-portion may be two or more prongs. The prongs may extend above a top of the top-cylindrical-portion. Between the prongs and the top-cylindrical-portion may be gaps that are configured to receive at least portion of the sleeve-structure therein. And upper regions of the prongs may anchor onto portions of the lighting-frame.

### PRIORITY NOTICE

The present application, a continuation-in-part (CIP) application, claims priority under 35 U.S.C. § 120 to U.S. Non-Provisional patent application Ser. No. 19/057,375 filed on Feb. 19, 2025, the disclosure of which is incorporated herein by reference in its entirety.

The present application, a continuation-in-part (CIP) application, claims priority under 35 U.S.C. § 120 to U.S. Non-Provisional patent application Ser. No. 19/020,672 filed on Jan. 14, 2025, the disclosure of which is incorporated herein by reference in its entirety.

The present application, a continuation-in-part (CIP) application, claims priority under 35 U.S.C. § 120 to U.S. Non-Provisional patent application Ser. No. 19/005,849 filed on Dec. 30, 2024, the disclosure of which is incorporated herein by reference in its entirety.

The present application, a continuation-in-part (CIP) application, claims priority under 35 U.S.C. § 120 to U.S. Non-Provisional patent application Ser. No. 18/597,114 filed on Mar. 6, 2024, the disclosure of which is incorporated herein by reference in its entirety.

The present application, a continuation-in-part (CIP) application, claims priority under 35 U.S.C. § 120 to U.S. Non-Provisional patent application Ser. No. 29/894,010 filed on Jun. 5, 2023, the disclosure of which is incorporated herein by reference in its entirety.

The present application, a continuation-in-part (CIP) application, claims priority under 35 U.S.C. § 120 to U.S. Non-Provisional patent application Ser. No. 29/962,228 filed on Sep. 10, 2024, the disclosure of which is incorporated herein by reference in its entirety.

The present application, a continuation-in-part (CIP) application, claims priority under 35 U.S.C. § 120 to U.S. Non-Provisional patent application Ser. No. 29/981,337 filed on Dec. 30, 2024, the disclosure of which is incorporated herein by reference in its entirety.

### CROSS REFERENCE TO RELATED PATENTS

The disclosures and teachings of the following U.S. patents, by the same inventor as the present patent application are all incorporated by reference as if fully set forth herein: D935082; U.S. Pat. Nos. 10,914,465; 11,092,326; 11,300,259; 11,466,849; 11,686,463; 11,668,458; 11,649,954; 12,066,175; 12,196,390; and 12320501.

### TECHNICAL FIELD OF THE INVENTION

The present invention relates in general to above ceiling frames for recessed lighting fixtures, and recessed lighting fixtures; and more specifically to an extension clip-in-collar for extending a sleeve of such frames to accommodate thicker ceilings.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Presently (circa 2025) in recessed lighting applications in ceilings, a lighting-frame is installed above a given ceiling, often in between two adjacent ceiling joists (e.g., using hanger-bars [or the like] to attached the lighting-frame to those joists), and attached to that installed lighting-frame will be a light-module (light fixture), where at least most of that light-module is generally located above that ceiling (and mostly above that lighting-frame), where lights shines out of a bottom of that light-module, through a main-hole in the lighting-frame and through a hole in the ceiling. Very often those lighting-frames are specifically manufactured with specific fixed sizes and dimensions to accommodate the most common ceiling thicknesses, which are often about the thickness of a single sheet of drywall. That is, many ceilings in the U.S. (especially in residential settings) have a thickness formed from a single layer of drywall, often at ⅝ of an inch nominally sized sheets of drywall (or at ½ of an inch nominally sized sheets of drywall). And many of the preexisting lighting-frames are specifically manufactured with specific fixed sizes and dimensions to accommodate a ceiling thickness of about ⅝ of an inch (or ½ of an inch). For example, many of those preexisting lighting-frames have a descending sleeve-structure, that extends downwards from a bottom surface of the given lighting-frame, and extends a distance of about ⅝ of an inch (or about ½ of an inch) to accommodate ceilings made from a single layer of drywall.

However, not all ceilings are made from a single layer of drywall; and/or some ceilings may have an overall thickness (or effective thickness) that may be thicker than ⅝ of inch (or thicker than ½ of an inch). Sometimes ceilings may be formed from drywall plus other product(s) (such as, but limited to, siding products) that results in the overall thickness for such a ceiling being more than ⅝ of an inch thick; and/or a ceiling may be formed from plywood (or the like) at a thickness greater than ⅝ of an inch; and/or a ceiling may be formed from plywood (or the like) plus other product(s) that results in the overall thickness for such a ceiling being more than ⅝ of an inch thick.

But the preexisting lighting-frames are generally not dimensioned to accommodate such thicker ceilings; i.e., in these preexisting lighting-frames their sleeve-structures (if any) do not reach to a bottom surface of the thicker ceiling and may not even each a hole in the thicker ceiling. And that may create problems for attaching the light-module to the lighting-frame and/or with attaching trim to the light-module. If a distance is too great between a bottom of a light-module and a top of a trim, that trim may not be attachable to that light-module because of the thicker ceiling.

A work around to that problem is use an extension collar, that essentially effectively extends how far the sleeve-structure extends below a bottom of the given lighting-frame. But current/preexisting such extension collars require using screws (or the like fasteners) and drivers (e.g., screwdriver, drill, impact driver, and/or the like) (i.e., requiring using separate, distinct, and external tools) to attach the preexisting extension collar to the preexisting lighting-frame.

It would be desirable for an extension-collar to be configured to be (removably) attached to the lighting-frame without a need for any separate, distinct, and external tools. It would be desirable for an extension-collar to be configured to be (removably) attached to the lighting-frame by a person merely pushing that extension-collar up against the lighting-frame until the extension-collar attaches itself to the lighting-frame.

There is a need in the art for such an extension-collar that is configured to be (removably) attached to a lighting-frame without using any separate, distinct, and external tools; and wherein that extension-collar is configured to be (removably) attached to the lighting-frame by a person merely pushing that extension-collar up against the lighting-frame until the extension-collar attaches itself to the lighting-frame.

It is to these ends that the present invention has been developed.

### BRIEF SUMMARY OF THE INVENTION

To minimize the limitations in the prior art, and to minimize other limitations that will be apparent upon reading and understanding the present specification, the present invention may describe an extension-collar for effectively extending a bottom length (height) of a sleeve-structure of a lighting-frame for a purpose of accommodating a thick ceiling (e.g., a ceiling that may be thicker than a single sheet of drywall). Without such an extension-collar, the sleeve-structure of a lighting-frame typically extends downwards from a bottom of the lighting-frame a fixed distance, referred to herein as “height-of-sleeve” that is dimensionally about a thickness of a single sheet of drywall, which might be ½ inch or ⅝ inch (most commonly). In some embodiments, a given extension-collar may be configured to be clipped onto a descending sleeve-structure of a given lighting-frame, in order to effectively extend a height of that sleeve-structure downwards, to accommodate a thick (or thicker) ceiling that may be thicker than a typical drywall ceiling (of single sheet thickness). In some embodiments, this extension-collar may be attached to the sleeve-structure (of the lighting-frame) without use of separate, distinct, and/or external tools. In some embodiments, this extension-collar may be attached to the sleeve-structure (of the lighting-frame) merely by a person pressing the extension-collar upwards against the sleeve-structure until the sleeve-structure is seated within gaps of the extension-collar and certain geometry prongs of the extension-collar engage a top deck of the lighting-frame, and all without using any separate, distinct, and/or external tools. Such a lighting-frame is typically installed above a given ceiling, in between joists, and receives a lighting-module. In some embodiments, the extension-collar may have a top-cylindrical-portion and a bottom-cylindrical-portion (that are integral with each other); and extending upwards from the bottom-cylindrical-portion may be two or more prongs. In some embodiments, upper (top) portions of these prongs may extend above a top of the top-cylindrical-portion. In some embodiments, between the prongs and the top-cylindrical-portion may be gaps that are configured to receive at least portion of the sleeve-structure therein when the extension-collar is attached (or being attached) to lighting-frame. In some embodiments, upper regions of the prongs may anchor onto portions of the lighting-frame when the extension-collar is attached to the lighting-frame. In some embodiments, attachment between a given extension-collar and a given lighting-frame may be removable. In some embodiments, detachment of a given extension-collar from a given lighting-frame may not require use of any separate, distinct, and/or external tools; i.e., to detach the upper portions of the prongs may need to be (simultaneously) squeezed inwards by a person while that person also pulls the extension-collar away from the lighting-frame and away from its sleeve-structure (e.g., pulling the extension-collar downwards if the lighting-frame were attached to joists).

It is an objective of the present invention to provide an extension-collar that effectively extends material below a lighting-frame for at least a purpose of being to use that lighting-frame with ceilings that may be thicker than a single sheet of drywall.

It is another objective of the present invention to provide such an extension-collar that is sufficiently strong for its intended purpose.

It is another objective of the present invention to provide such an extension-collar that is easy to use, easy to install, not requiring any separate, distinct, and/or external tools for attachment to the given lighting-frame.

It is another objective of the present invention to provide such an extension-collar that is easy to use, easy to uninstall, not requiring any separate, distinct, and/or external tools for detachment of the extension-collar from the lighting-frame.

It is another objective of the present invention to provide such an extension-collar that is easy to make and/or manufacture.

It is yet another objective of the present invention to provide such an extension-collar that may be readily mass produced using currently existing mass manufacturing techniques and/or equipment.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A depicts a bottom perspective view of an extension-clip-in-collar (i.e., an “extension-collar” or a “collar”) according to at least one embodiment.

FIG. 1B depicts another bottom perspective view of the collar of FIG. 1A.

FIG. 1C depicts a front view of the collar of FIG. 1A.

FIG. 1D depicts a rear (back) view of the collar of FIG. 1A.

FIG. 1E depicts a right-side view of the collar of FIG. 1A.

FIG. 1F depicts a left-side view of the collar of FIG. 1A.

FIG. 1G depicts a top view of the collar of FIG. 1A.

FIG. 1H depicts a bottom view of the collar of FIG. 1A.

FIG. 2A depicts an exploded view of the collar of FIG. 1A from a bottom perspective view.

FIG. 2B depicts another exploded view of the collar of FIG. 1A from another bottom perspective view.

FIG. 2C depicts another exploded view of the collar of FIG. 1A from another bottom perspective view.

FIG. 2D depicts another exploded view of the collar of FIG. 1A from a front view.

FIG. 3A depicts a system (or a kit) of a given collar (removably) installed into a frame (lighting-frame), shown from a top perspective view (of that collar and/or of that frame).

FIG. 3B depicts the system (the kit) of FIG. 3A, but now shown from a front view of that collar (and/or from a side view of that frame).

FIG. 3C depicts the system (the kit) of FIG. 3A, but now shown from a top view of that collar (and/or from a top view of that frame).

FIG. 3D depicts the system (the kit) of FIG. 3A, but now shown from a bottom perspective view (of that collar and/or of that frame).

FIG. 3E depicts the system (the kit) of FIG. 3A, but now shown from another top perspective view (of that collar and/or of that frame).

FIG. 4A depicts a system (a kit) of a given collar (removably) installed into a frame (lighting-frame), and with a light-module attached to and/or in operative communication with that frame, shown from a top perspective view (of that collar, of that frame, and/or of that light-module).

FIG. 4B depicts the system (the kit) of FIG. 4A, but now shown from a bottom perspective view (of that collar, of that frame, and/or of that light-module).

FIG. 4C depicts the system (the kit) of FIG. 4A, but now shown from a front view of that collar (and/or a side view of that frame).

FIG. 5A is a front (or rear) view of a frame (lighting-frame), with an attached collar, including a trim, but omitting at least upper portions of a light-module (such as, but not limited to, omitting a heat-sink and/or omitting a housing from FIG. 5A); and FIG. 5A includes a sectional-line 5B-5B for generating FIG. 5B.

FIG. 5B may be a cross-sectional view through at least a portion of a collar, a frame, a trim, and a lighting-module along sectional-line 5B-5B, wherein sectional-line 5B-5B is depicted in FIG. 5A.

FIG. 6A shows a given frame (lighting-frame) with a light-module attached to and/or in operative communication with that frame, wherein those items may be installed above a typical drywall (or the like) ceiling, shown from a side view of that frame (no collar is included in FIG. 6A).

FIG. 6B depicts a system (a kit) with a given collar (removably) installed into a given frame (lighting-frame), and with a light-module attached to and/or in operative communication with that frame, wherein that system (kit) may be at least mostly installed above a given (thicker) ceiling, shown from a front view of that collar (and/or a side view of frame).

### REFERENCE NUMERAL SCHEDULE

100 extension-clip-in-collar (collar) 100
103 bottom-cylindrical-portion 103
107 bottom 107
109 top 109
111 inside-sidewall 111
113 prong 113
115 exterior-sidewall 115
117 prong-end 117
119 permanent-attachment-end 119
121 prong-hole 121
123 sidewall-hole 123
125 bottom-hole 125
127 top-hole 127
129 height-of-bottom-portion 129
131 height-of-top-portion 131
133 transition 133
135 common (shared) central axis (center line) 135
137 bottom-inside-diameter 137
139 top-inside-diameter 139
141 bottom-outside-diameter 141
143 top-outside-diameter 143
145 gap 145
147 first-bend 147 (outward-bend 147)
149 second-bend 149 (inward-bend 149)
300 system (kit) 300
301 frame 301
303 deck 303
305 top 305
307 sleeve-structure 307
309 opening 309
311 height-of-sleeve 311
313 outside-diameter 313
315 inside-diameter 315
317 bottom-surface 317
400 system (kit) 400
401 light-module 401
403 heat-sink 403
405 driver-housing 405
407 trim 407
409 flange 409
411 interior-sidewall 411
513 reflector 513
515 holder-for-light-module 515
517 tension-clip(s) 517
601 joist(s) 601
603 hanger-bar(s) 603
605 ceiling 605
607 celing-thickness 607 p1 609 hole-in-ceiling 609
611 ceiling 611
613 ceiling-thickness 613
615 hole-in-ceiling 615

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

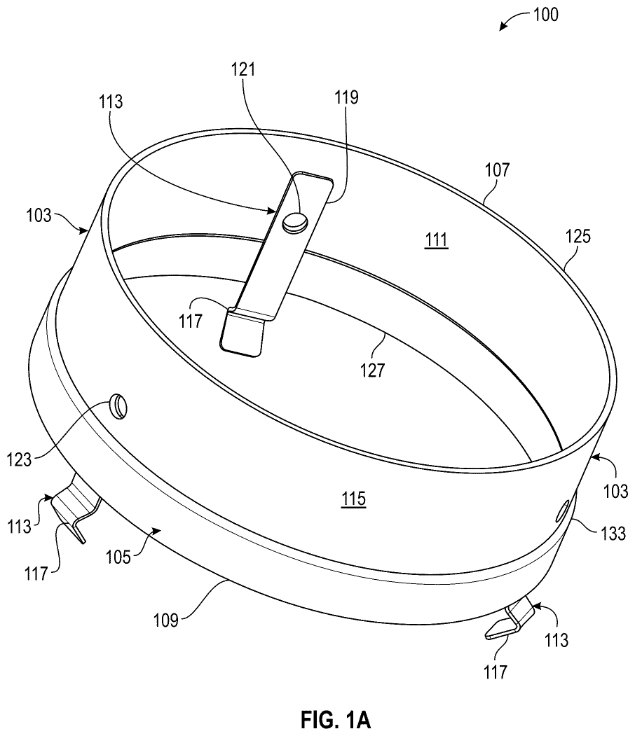

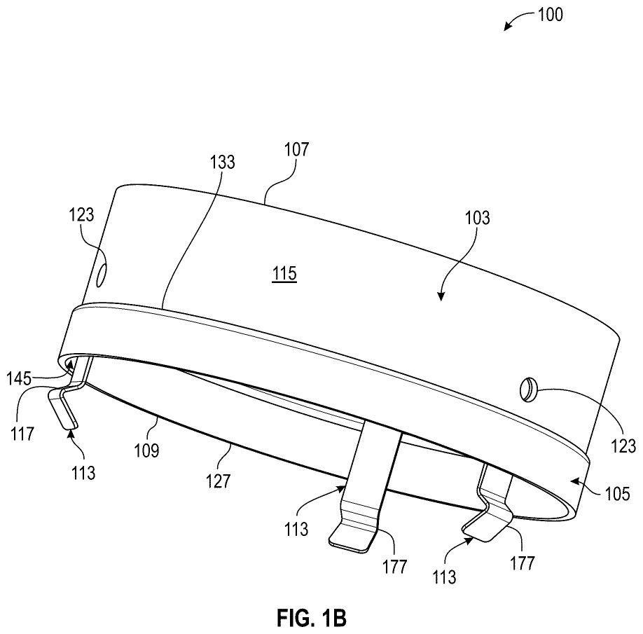

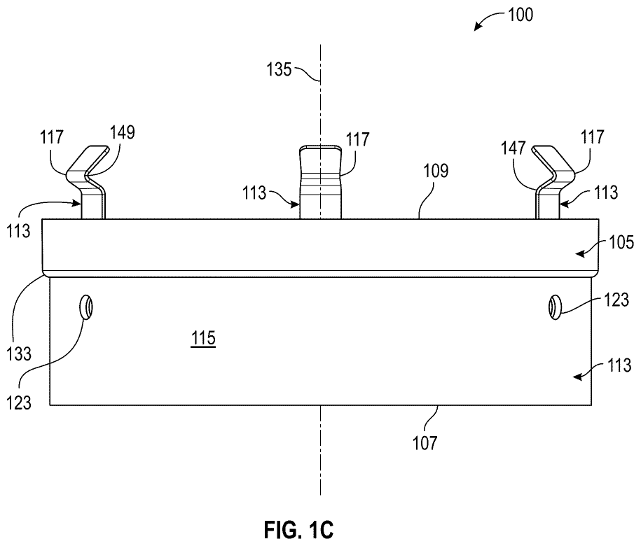

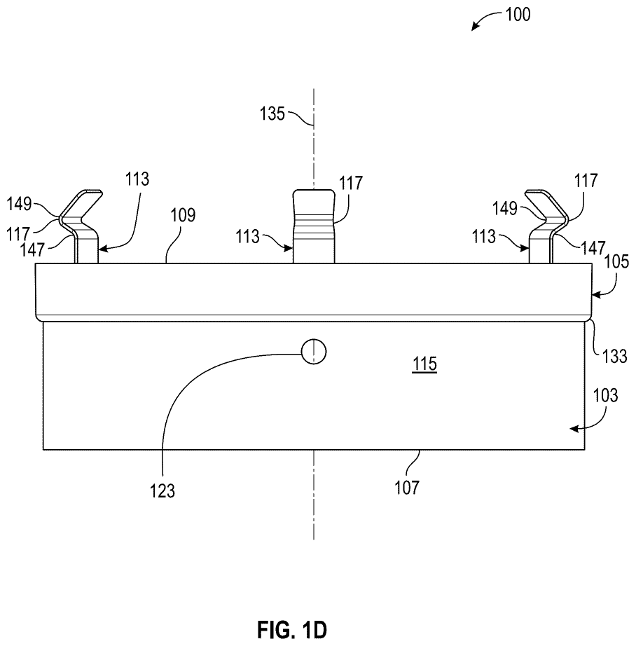

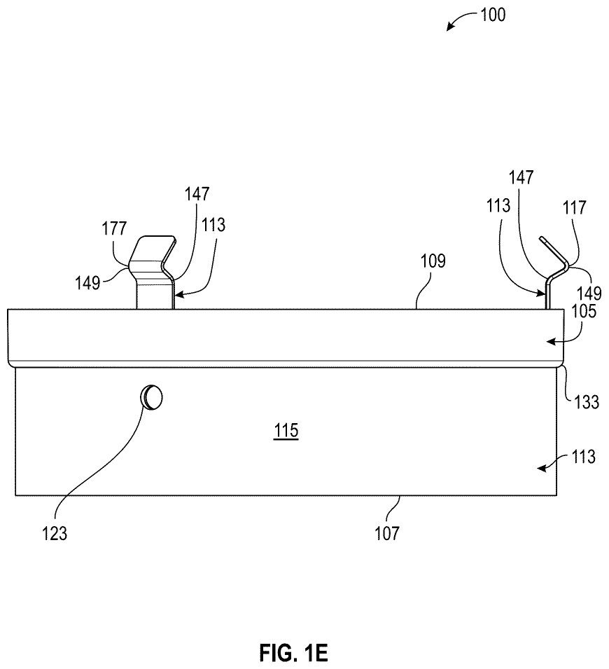

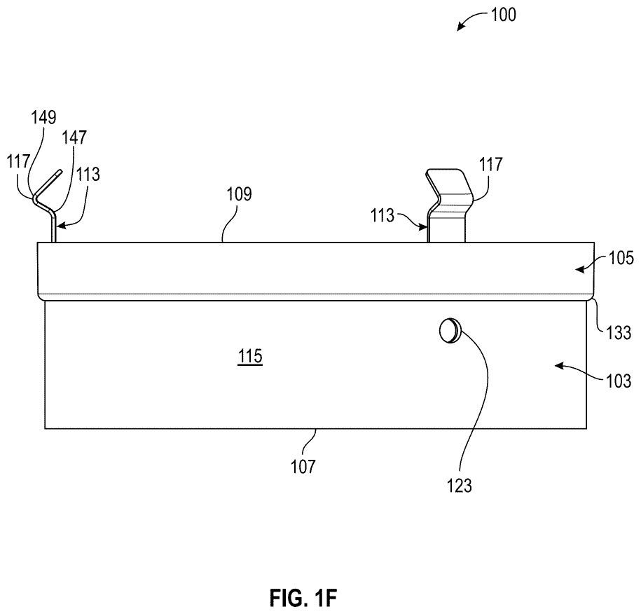

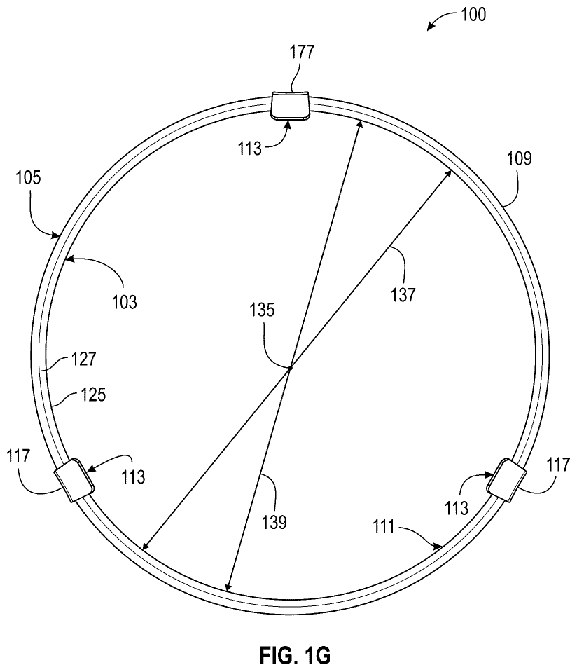

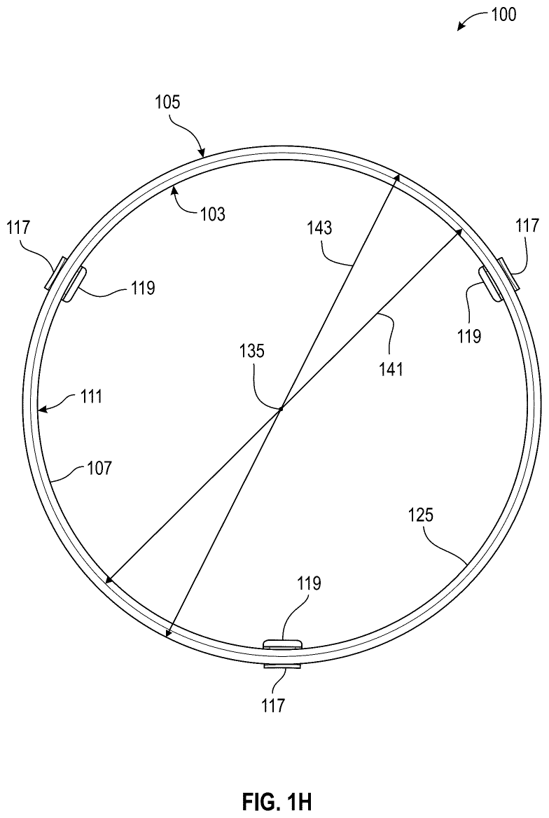

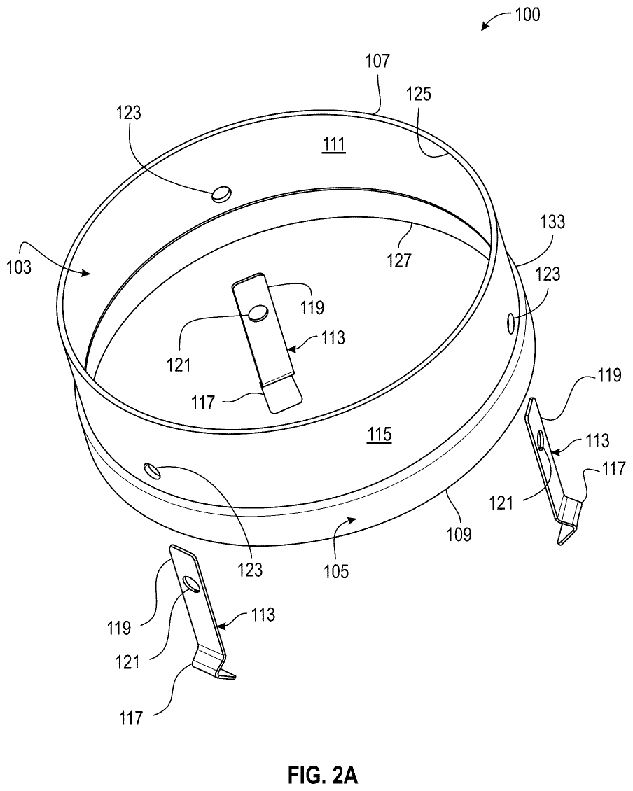

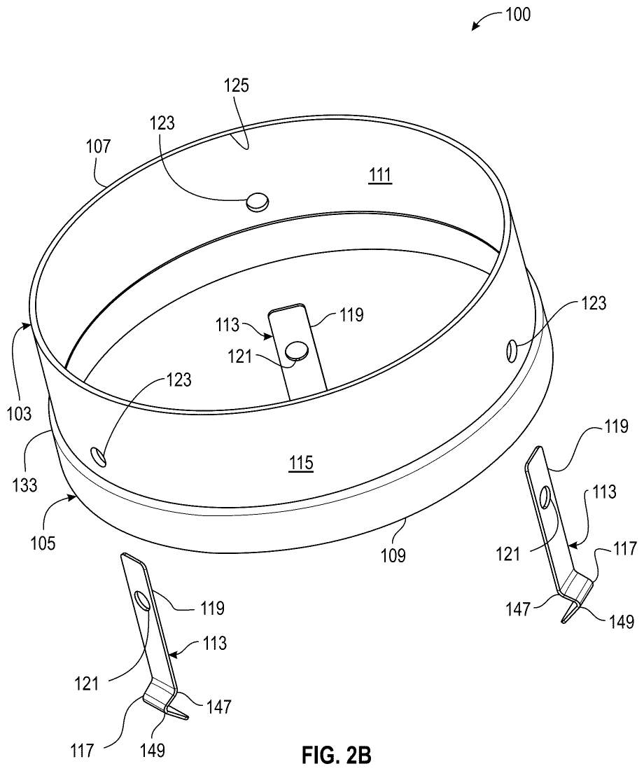

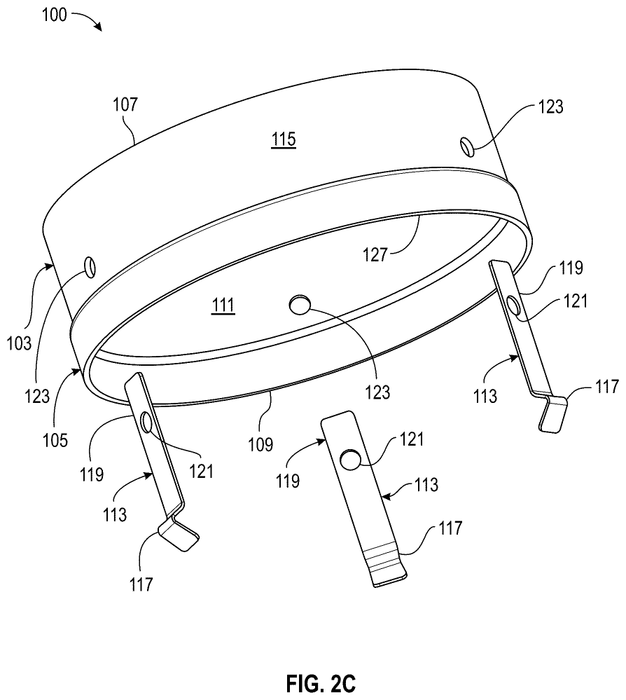

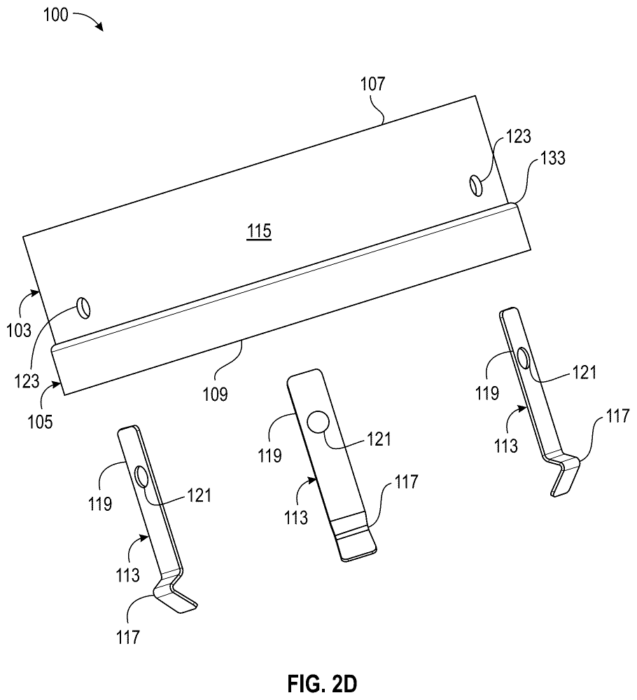

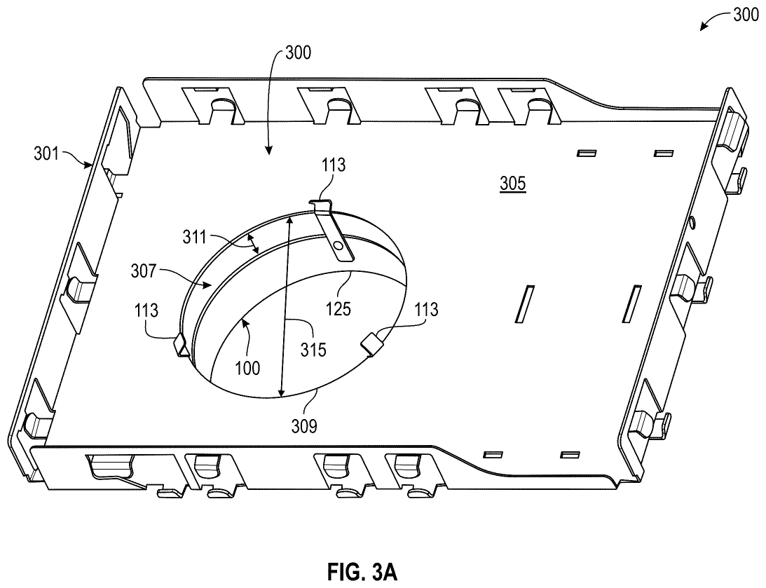

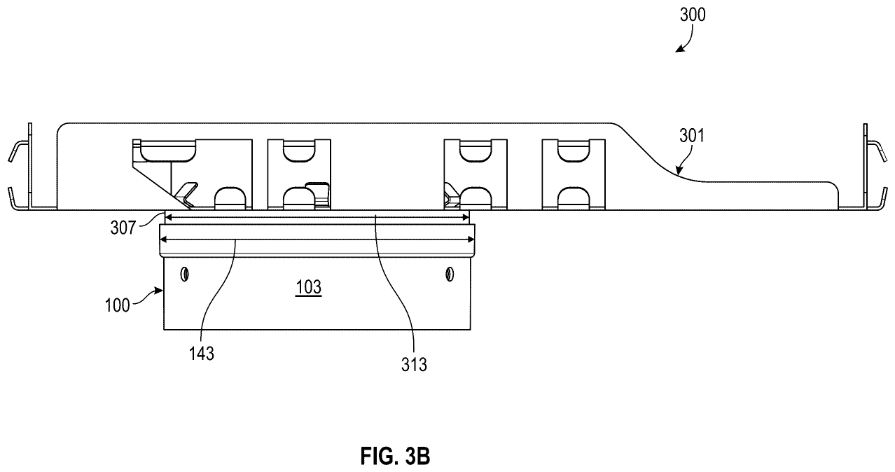

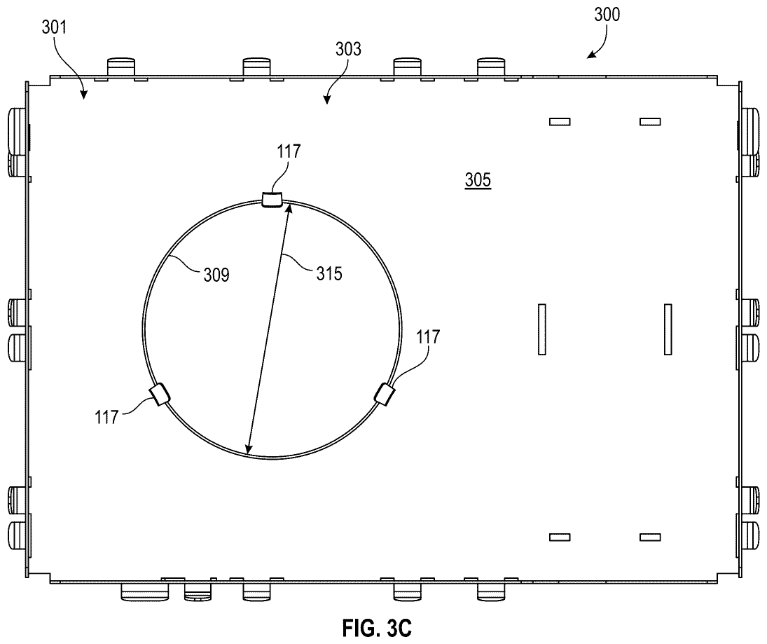

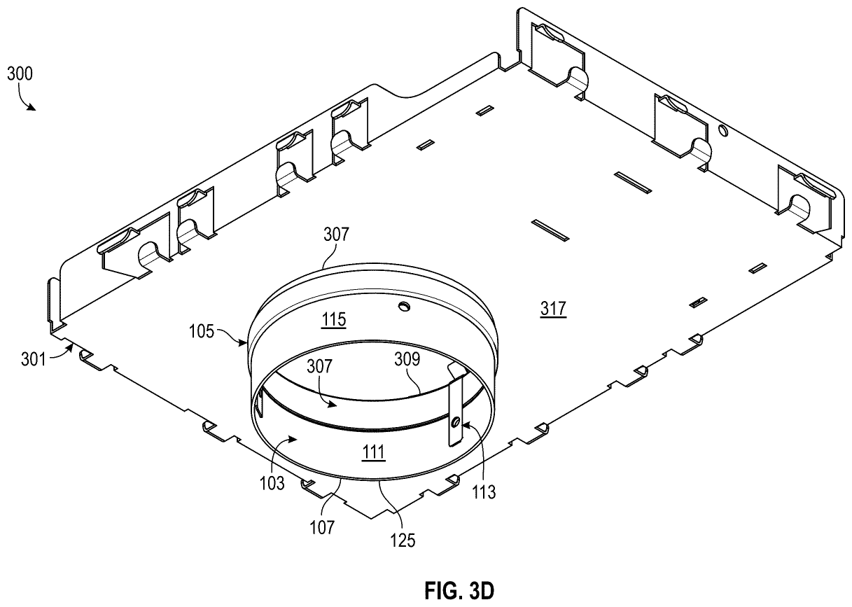

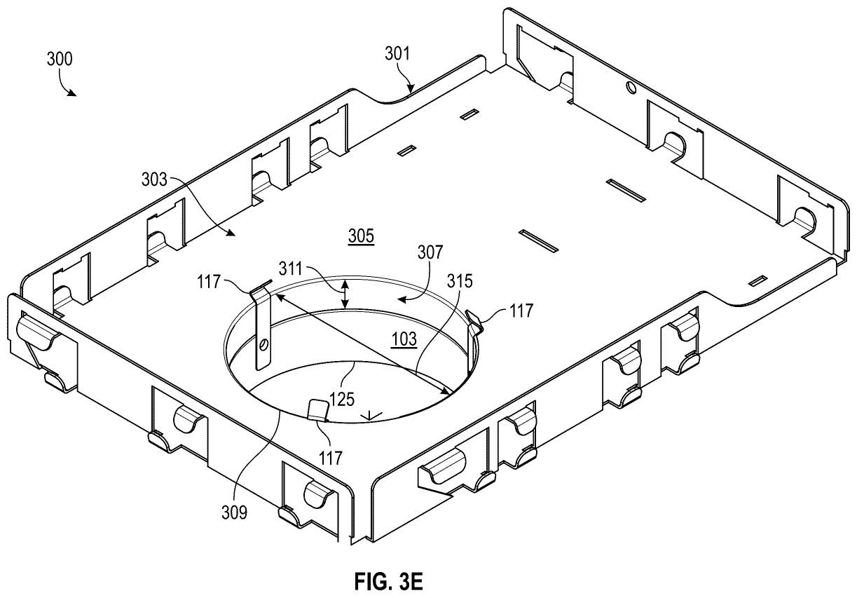

Note, functionality of an extension-clip-in-collar 100 (collar 100) may be shown in FIG. 3A to FIG. 5B, where collar 100 may removably attach to a given frame 301 and/or interact with a given light-module 401; whereas, FIG. 1A to FIG. 2D may show just collar 100 by itself.

FIG. 1A depicts a bottom perspective view of an extension-clip-in-collar 100 (i.e., an extension-collar 100 or a collar 100 for terminology). In some embodiments, “extension-clip-in-collar 100,” “extension-collar 100,” and/or “collar 100” (and/or “extension-clip-in-collar,” “extension-collar,” and/or “collar”) may be used interchangeably herein, all referring to a same assembly 100 shown in FIG. 1A to FIG. 1F. FIG. 1B depicts another bottom perspective view of collar 100. FIG. 1C depicts a front view of collar 100. Note, in FIG. 1C the middle shown prong 113 may be furthest away of the three shown prongs 113 from the viewer of FIG. 1C. FIG. 1D depicts a rear (back) view of collar 100. Note, in FIG. 1D the middle shown prong 113 may be closest of the three shown prongs 113 to the viewer of FIG. 1D. FIG. 1E depicts a right-side view of collar 100. In FIG. 1E there may be three prongs 113, however a left front side prong 113 may be covering over a left rear side prong 113 in FIG. 1E. FIG. 1F depicts a left-side view of collar 100. In FIG. 1F there may be three prongs 113, however a right front side prong 113 may be covering over a right rear side prong 113 in FIG. 1F. In some embodiments, a given collar 100 may comprise two at least substantially (mostly) cylindrical portions that may be seamlessly attached to each other without any gaps nor any interruptions between each such cylindrical portion, namely, a bottom-cylindrical-portion 103 and a top-cylindrical-portion 105. In some embodiments, a bottom of top-cylindrical-portion 105 may be attached to a top of bottom-cylindrical-portion 103. In some embodiments, where bottom-cylindrical-portion 103 may end on its top, top-cylindrical-portion 105 may begin. In some embodiments, bottom-cylindrical-portion 103 and top-cylindrical-portion 105 may be integral with each other, as a single article of manufacture. In some embodiments, a bottom 107 of bottom-cylindrical-portion 103 may be a bottom of collar 100. In some embodiments, a top 109 of top-cylindrical-portion 105 may be a top of collar 100.

Continuing discussing, FIG. 1A to FIG. 1F, of a given collar 100, in some embodiments, attached to an inside-sidewall 111 of bottom-cylindrical-portion 103 may be at least one prong 113. In some embodiments, collar 100, bottom-cylindrical-portion 103, and/or inside-sidewall 111 may comprise at least one prong 113. In some embodiments, collar 100, bottom-cylindrical-portion 103, and/or inside-sidewall 111 may comprise one or more prongs 113. In some embodiments, collar 100, bottom-cylindrical-portion 103, and/or inside-sidewall 111 may comprise two or three prongs 113. In some embodiments, when collar 100, bottom-cylindrical-portion 103, and/or inside-sidewall 111 may have two or more prongs 113, those prongs 113 may be arranged equidistant from each other on (attached to) inside-sidewall 111. In some embodiments, at least a portion of a given prong 113 may be permanently attached to inside-sidewall 111 of bottom-cylindrical-portion 103. In some embodiments, at least a portion of a given prong 113 may be welded to inside-sidewall 111 of bottom-cylindrical-portion 103. In some embodiments, no portion of a given prong 113 may directly touch any portion of top-cylindrical-portion 105 (see e.g., FIG. 1B). In some embodiments, each prong 113 of collar 100, bottom-cylindrical-portion 103, and/or inside-sidewall 111 may be structurally, functionally, and/or dimensionally identical with each other, including made from identical material(s) of construction; i.e., their only difference from each other may be their respective attachment locations on inside-sidewall 111. In some embodiments, a given prong 113 may be an elongate-member of fixed (finite) length, with two opposing terminal-ends, namely, a prong-end 117 and a permanent-attachment-end 119. In some embodiments, the prong-end 117 terminal-end of a given prong 113 may extend above top 109 of collar 100 and may be configured for enabling removable attachment of a given collar 100 to a given frame 301, by the prong-ends 117 resting on top 305 of a deck 303 of that frame 301 at a sleeve-structure 307 opening 309 of that given frame 301 (see e.g., FIG. 3A) when that given collar 100 may be removably attached to that given frame 301. In some embodiments, a given prong 113 may be longer that it is wide, and wider than it is thick.

Continuing discussing, FIG. 1A to FIG. 1F, of prong(s) 113, in some embodiments, prong-end 117 and permanent-attachment-end 119 may be disposed opposite from each other. In some embodiments, prong-end 117 may be devoid of any holes and/or apertures. In some embodiments, the permanent-attachment-end 119 terminal-end (portion) of a given prong 113 may be at least a portion of that given prong 113 that is attached to inside-sidewall 111. In some embodiments, prong 113 may not touch bottom 107 nor touch top 109. In some embodiments, permanent-attachment-end 119 (and/or prong-end 117) may not touch bottom 107 nor touch top 109. In some embodiments, a given prong 113 and/or permanent-attachment-end 119 may comprise at least one prong-hole 121. In some embodiments, prong-hole 121 may be through hole (aperture) in prong 113 and/or in permanent-attachment-end 119. In some embodiments, bottom-cylindrical-portion 103 may comprise at least one sidewall-hole 123 in its sidewall. In some embodiments, sidewall-hole 123 may be a through hole (aperture) in a sidewall of bottom-cylindrical-portion 103. In some embodiments, there may be one sidewall-hole 123 for each prong 113. In some embodiments, prong-hole 121 may be concentric with one sidewall-hole 123 of bottom-cylindrical-portion 103. In some embodiments, prong-hole 121 and sidewall-hole 123 may be a same size as each other. In some embodiments, no such prong(s) 113 may be attached nor located on an exterior-sidewall 115 of bottom-cylindrical-portion 103 and/or of top-cylindrical-portion 105. In some embodiments, exterior-sidewall 115 of bottom-cylindrical-portion 103 and/or top-cylindrical-portion 105 may be completely free of any such prong(s) 113.

As shown in FIG. 1E, in some embodiments, with respect to a given prong 113 where its permanent-attachment-end 119 is fixedly and permanently attached to inside-sidewall 111 (e.g., at a given sidewall-hole 123), the prong-end 117 may first bend outwards (e.g., at a first-bend 147 or outward-bend 147) away from a common (shared) central axis 135 (and/or away from an exterior surface of top-cylindrical-portion 105) and run for fixed for a distance after that first-bend 147; and then may bent inwards (e.g., at a second-bend 149 or inward-bend 149) back towards common (shared) central axis 135 and then run for a short fixed distance. In some embodiments, both first-bend 147 (outward-bend 147) and second-bend 149 (inward-bend 149) are fixed and non-variable angles for a given embodiment of collar 100 and/or of prong 113. In some embodiments, first-bend 147 (outward-bend 147) may be a fixed angle that is greater than ninety (90) degrees. In some embodiments, first-bend 147 (outward-bend 147) may be a fixed angle selected from 120 degrees to 150 degrees (including being able to select from one of those endpoints of that range). In some embodiments, first-bend 147 (outward-bend 147) (or region(s) immediately adjacent to, proximate to first-bend 147 [outward-bend 147] of prong 113/prong-end 117) may reside on, press against, push against, and/or be in direct physical contact with a portion of top 305 of deck 303 of frame 301 around opening 309 as shown in FIG. 3A. Continuing discussing FIG. 1E, in some embodiments, second-bend 149 (inward-bend 149) may be a fixed angle that is less than ninety (90) degrees. In some embodiments, first-bend 147 (outward-bend 147) may extend and/or may be located outside (to an exterior) of top-cylindrical-portion 105. In some embodiments, second-bend 149 (inward-bend 149) may be a fixed angle selected from eighty-five (85) degrees to seventy (70) degrees (including being able to select from one of those endpoints of that range). See e.g., FIG. 1E.

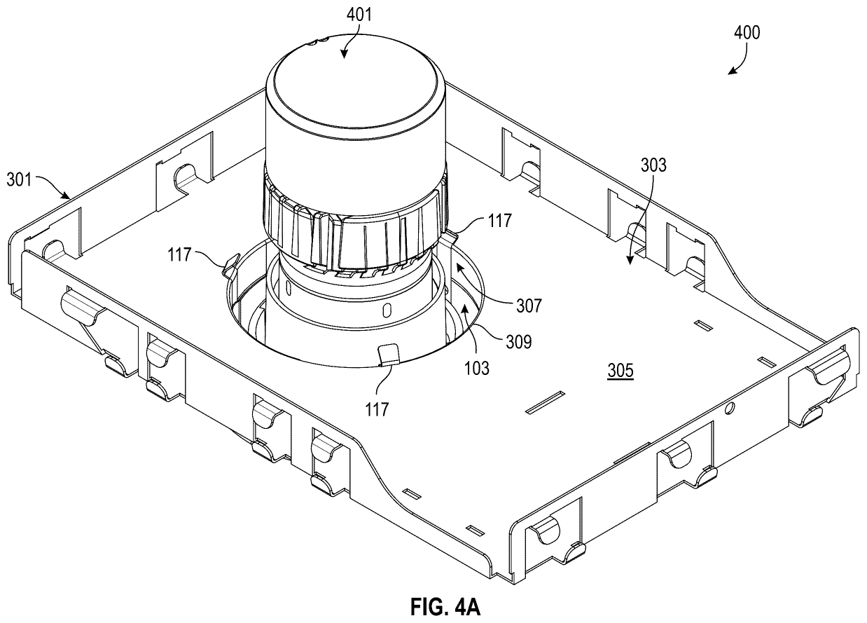

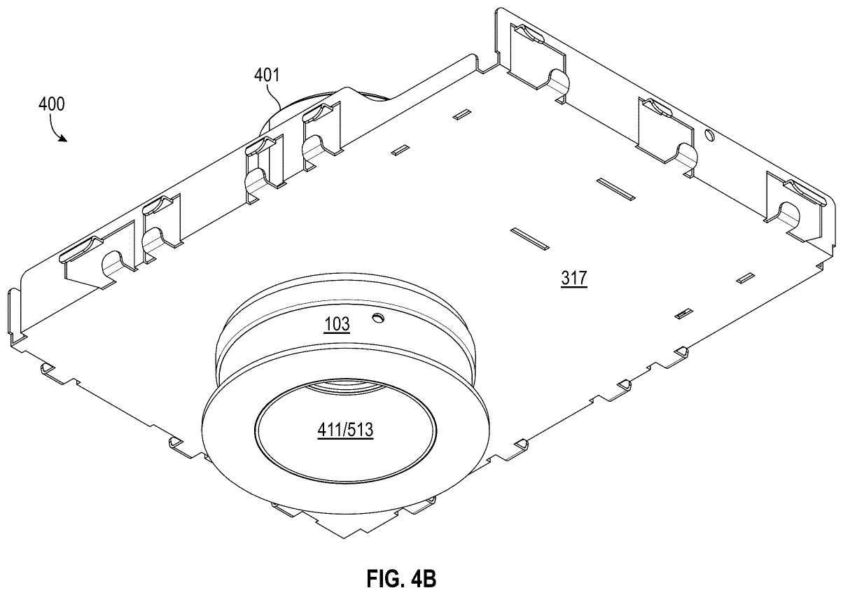

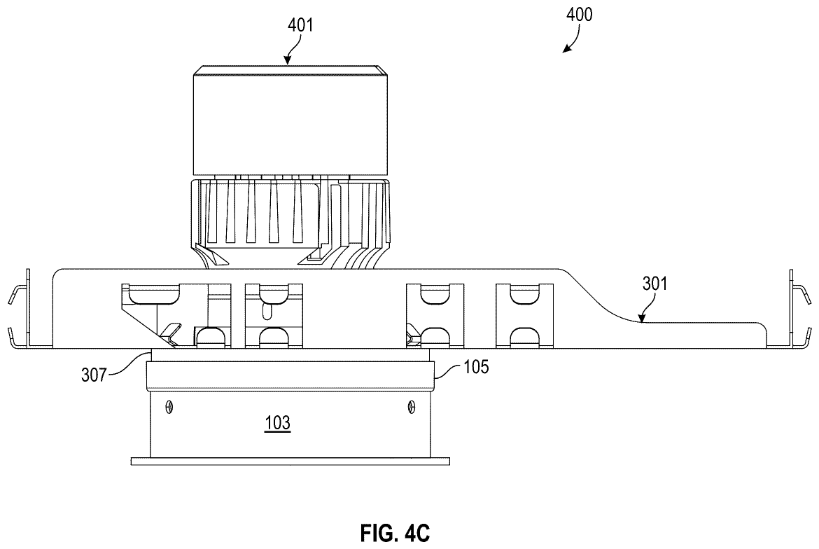

Continuing discussing, FIG. 1A to FIG. 1F, of collar 100, in some embodiments, located at bottom 107 may be a single bottom-hole 125. In some embodiments, located at top 109 may be a single top-hole 127. In some embodiments, bottom-hole 125 may be disposed opposite from top-hole 127. In some embodiments, top-hole 127 may be larger than bottom-hole 125. In some embodiments, top-hole 127 may be largest hole of collar 100, of frame 301, and/or of light-module 401 (see e.g., FIG. 3A for frame 301 and see FIG. 4A for light-module 401). Continuing discussing, FIG. 1A to FIG. 1F, of collar 100, in some embodiments, bottom-hole 125 may be a second largest hole of collar 100. In some embodiments, bottom-hole 125 and/or top-hole 127 may be non-elastic. In some embodiments, a dimension of top-hole 127 and/or a dimension of top-hole 127 may be fixed and non-variable for a given embodiment of collar 100. In some embodiments, bottom-hole 125 may be larger than prong-hole 121 and/or larger than sidewall-hole 123. In some embodiments, top-hole 127 may be larger than prong-hole 121 and/or larger than sidewall-hole 123. In some embodiments, both bottom-cylindrical-portion 103 and top-cylindrical-portion 105 may share an interior void space (volume) (when collar 100 is not attached to other structures and/or when collar 100 is not interacting with other structures).

Discussing FIG. 1E and/or FIG. 1F, in some embodiments, a height 129 of bottom-cylindrical-portion 103 may be larger than a height 131 of top-cylindrical-portion 105. In some embodiments, height 129 may be a height of bottom-cylindrical-portion 103. In some embodiments, height 131 may be a height of top-cylindrical-portion 105. In some embodiments, height 131 may be shorter than height 129. In some embodiments, height 129 may be different from height 131. In some embodiments, height 129 may be fixed, finite, non-variable, and/or uniform for all of bottom-cylindrical-portion 103. In some embodiments, height 131 may be fixed, finite, non-variable, and/or uniform for all of top-cylindrical-portion 105. In some embodiments, height 129 may be a height that is the same or larger than a thickness of a given ceiling. In some embodiments, height 131 may be a height that is the same or larger than a height 311 of sleeve-structure 307 (see e.g., FIG. 3A for sleeve-structure 307 and height 311).

Continuing discussing FIG. 1E and/or FIG. 1F, in some embodiments, bottom-cylindrical-portion 103 may transition into top-cylindrical-portion 105 at transition 133. In some embodiments, transition 133 may be an interface between bottom-cylindrical-portion 103 and top-cylindrical-portion 105. In some embodiments, transition 133 may be where bottom-cylindrical-portion 103 is joined into top-cylindrical-portion 105. In some embodiments, transition 133 may be chamfered step. In some embodiments, transition 133 may be an outwardly extending chamfered step (located on an exterior of collar 100) as collar 100 transitions from bottom-cylindrical-portion 103 into top-cylindrical-portion 105.

FIG. 1G depicts a top view of collar 100. In a center of FIG. 1G shows a common (shared) central axis 135 (shown as a dot/point in a center of FIG. 1G). In some embodiments, bottom-cylindrical-portion 103 may be radially symmetric about common (shared) central axis 135 (except for its prongs 113 and/or its sidewall-hole(s) 123). In some embodiments, top-cylindrical-portion 105 may be radially symmetric about common (shared) central axis 135. In some embodiments, bottom-cylindrical-portion 103 and top-cylindrical-portion 105 may be concentric with each other with respect to common (shared) central axis 135 (see also FIG. 1H). Continuing discussing FIG. 1G, in some embodiments, when collar 100, bottom-cylindrical-portion 103, and/or inside-sidewall 111 may have three prongs 113, those prongs 113 may be arranged about one hundred and twenty (120) degrees from each other on (attached to) inside-sidewall 111 (see also FIG. 1H). Continuing discussing FIG. 1G, in some embodiments, bottom-cylindrical-portion 103 may have a fixed, finite, non-variable, and/or uniform thickness for all of bottom-cylindrical-portion 103. In some embodiments, top-cylindrical-portion 105 may have a fixed, finite, non-variable, and/or uniform thickness for all of top-cylindrical-portion 105. In some embodiments, collar 100 may be at least substantially radially symmetrical with around (with respect to) common (shared) central axis 135.

Continuing discussing FIG. 1G, in some embodiments, bottom-cylindrical-portion 103 may comprise a bottom-inside-diameter 137. In some embodiments, bottom-inside-diameter 137 may be an inside diameter of bottom-cylindrical-portion 103. In some embodiments, top-cylindrical-portion 105 may comprise a top-inside-diameter 139. In some embodiments, top-inside-diameter 139 may be an inside diameter of top-cylindrical-portion 105. In some embodiments, bottom-inside-diameter 137 may be different from top-inside-diameter 139. In some embodiments, bottom-inside-diameter 137 may be less than top-inside-diameter 139. In some embodiments, top-inside-diameter 139 may be greater than bottom-inside-diameter 137. In some embodiments, bottom-inside-diameter 137 may be fixed, finite, non-variable, and/or uniform for all of bottom-cylindrical-portion 103 (except where prongs 113 may interrupt that bottom-inside-diameter 137). In some embodiments, top-inside-diameter 139 may be fixed, finite, non-variable, and/or uniform for all of top-cylindrical-portion 105. In some embodiments, top-inside-diameter 139 may be larger than an inside-diameter 315 of sleeve-structure 307 (see e.g., FIG. 3A for sleeve-structure 307 and its inside-diameter 315). In some embodiments, top-inside-diameter 139 may be larger than an outside-diameter 313 of sleeve-structure 307 (see e.g., FIG. 3B for sleeve-structure 307 and its outside-diameter 313). In some embodiments, top-inside-diameter 139 may be configured to fit onto and/or around the outside-diameter 313 of sleeve-structure 307. In some embodiments, bottom-inside-diameter 137 may be about the same as outside-diameter 313 of sleeve-structure 307 (see e.g., FIG. 3A).

FIG. 1H depicts a bottom view of collar 100. In some embodiments, bottom-cylindrical-portion 103 may have a fixed, finite, non-variable, and/or uniform thickness for all of bottom-cylindrical-portion 103. In some embodiments, top-cylindrical-portion 105 may have a fixed, finite, non-variable, and/or uniform thickness for all of top-cylindrical-portion 105. In some embodiments, bottom-cylindrical-portion 103 may comprise a bottom-outside-diameter 141. In some embodiments, bottom-outside-diameter 141 may be an outside diameter of bottom-cylindrical-portion 103. In some embodiments, top-cylindrical-portion 105 may comprise a top-outside-diameter 143. In some embodiments, top-outside-diameter 143 may be an outside diameter of top-cylindrical-portion 105. In some embodiments, bottom-outside-diameter 141 may be different from top-outside-diameter 143. In some embodiments, bottom-outside-diameter 141 may be less than top-outside-diameter 143. In some embodiments, top-outside-diameter 143 may be greater than bottom-outside-diameter 141. In some embodiments, bottom-outside-diameter 141 may be fixed, finite, non-variable, and/or uniform for all of bottom-cylindrical-portion 103. In some embodiments, top-outside-diameter 143 may be fixed, finite, non-variable, and/or uniform for all of top-cylindrical-portion 105. In some embodiments, top-outside-diameter 143 may be larger than an outside-diameter 313 of sleeve-structure 307 (see e.g., FIG. 3B for sleeve-structure 307 and its outside-diameter 313). In some embodiments, bottom-outside-diameter 141 may be about the same as outside-diameter 313 of sleeve-structure 307 (see e.g., FIG. 3B).

FIG. 2A depicts an exploded view of collar 100 from a bottom perspective view. FIG. 2B depicts another exploded view of collar 100 from another bottom perspective view. FIG. 2C depicts another exploded view of collar 100 from another bottom perspective view. FIG. 2D depicts another exploded view of collar 100 from a front view. In some embodiments, collar 100 may be comprised of two different parts (components), namely, the (integral) cylindrical member (of bottom-cylindrical-portion 103 and of top-cylindrical-portion 105) and the prong(s) 113. In some embodiments, collar 100 may be comprised of: bottom-cylindrical-portion 103, top-cylindrical-portion 105, and at least one prong 113. In some embodiments, bottom-cylindrical-portion 103 and top-cylindrical-portion 105 together may form a single (integral) cylindrical member (e.g., as shown in FIGS. 2A to 2D).

In some embodiments, collar 100 may comprise: one bottom-cylindrical-portion 103, one top-cylindrical-portion 105, one bottom 107, one top 109, (one) inside-sidewall 111 (of bottom-cylindrical-portion 103), at least one prong 113, exterior-sidewall 115 (of bottom-cylindrical-portion 103 and/or top-cylindrical-portion 105), prong-end 117 (of a given prong 113), permanent-attachment-end 119 (of a given prong 113), prong-hole 121 (of a given prong 113 and/or of a given permanent-attachment-end 119), (optional) sidewall-hole 123 (one for each prong 113 in some embodiments), one (large) bottom-hole 125, one (largest) top-hole 127, one height-of-bottom-portion 129, one height-of-top-portion 131, one transition 133, one common (shared) central axis 135, one bottom-inside-diameter 137 (of bottom-cylindrical-portion 103), one top-inside-diameter 139 (of top-cylindrical-portion 105), one bottom-outside-diameter 141 (of bottom-cylindrical-portion 103), one top-outside-diameter 143 (of top-cylindrical-portion 105), thickness of bottom-cylindrical-portion 103, and thickness of top-cylindrical-portion 105. See e.g., FIG. 1A to FIG. 2D.

FIG. 3A depicts a system 300 (kit 300) of a given collar 100 (removably) installed into a frame 301, shown from a top perspective view (of that collar 100 and/or of that frame 301). In some embodiments, “frame 301” and/or “lighting-frame 301” (and/or “frame” and/or “lighting-frame”) may be used interchangeably herein, all referring to a same assembly/structure 301 shown in FIG. 3A to FIG. 6B. FIG. 3B depicts system 300 (kit 300) with the given collar 100 (removably) installed into the frame 301, shown from a front view of that collar 100 (or a side view of that frame 301). FIG. 3C depicts system 300 (kit 300) with the given collar 100 (removably) installed into the frame 301, shown from a top view of that collar 100 (and/or a top view of that frame 301). FIG. 3D depicts system 300 (kit 300) with that given collar 100 (removably) installed into that frame 301, shown from a bottom perspective view (of that collar 100 and/or of that frame 301). FIG. 3E depicts system 300 (kit 300) with that given collar 100 (removably) installed into that frame 301, shown from another top perspective view (of that collar 100 and/or of that frame 301). In some embodiments, system 300 (kit 300) may comprise one frame 301 and one collar 100. In some embodiments, system 300 (kit 300) may comprise at least one frame 301 and at least one collar 100. In some embodiments, a given frame 301 may be configured to serve as a physical structure permitting mounting of a light-module 401 (such as, but not limited to, a light fixture, a light source, a recessed light, and/or the like) above a given ceiling and typically between two parallel and adjacent joists (or the like) (for example, in a recessed lighting configuration). See e.g., FIG. 4A to FIG. 4C for a given light-module 401. For example, and without limiting the scope of the present invention, the frame 301 may be attached to and in between the two parallel and adjacent joists (or the like) (e.g., using hanger-bars [hangar-bars] or the like); and the given light-module 401 would be typically mounted to that given frame 301 (and possibly with a portion of that given light-module 401 descending below that given frame 301 and other portion(s) of that given light-module 401 being located above that given frame 301). Typically, once the ceiling is installed the given frame 301 may be entirely hidden from view (e.g., from an observer located below that installed ceiling); and the only item visible may be a trim (e.g., flange portion) of the light-module 401 and/or an optical reflector portion of the light-module 401 and/or the trim. In some embodiments, a given frame 301 (of the present [instant] patent application) may be selected from at least one of: “frame 601” from U.S. utility U.S. Pat. No. 11,686,463; “mounting frame 103” from U.S. utility U.S. Pat. No. 12,196,390 and/or from U.S. patent application Ser. No. 19/005,849; “mounting-frame 201” from U.S. utility U.S. Pat. No. 12,196,390 and/or from U.S. patent application Ser. No. 19/005,849; “frame-assembly 101” from U.S. utility U.S. Pat. No. 12,320,501; and/or the like; wherein the contents, disclosures, and teachings of those patents and patent application are hereby incorporated by reference as if fully set forth herein. In some embodiments, a given frame 301 (of the present [instant] patent application) may be selected from at least one of the following products: EL276ICA, EL276ICDXA, E2LK34ICA, E2LK35ICAD, E2LK41ICA, E2LK42ICAD, E21KT10ICAD, E2LK94ICA, E2LK95ICAD, E24V276ICA, or E2LKF1 (all of which from AMP Plus, Inc. dba ELCO Lighting), wherein the contents, disclosures, and teachings of those products are hereby incorporated by reference as if fully set forth herein. Note, in some embodiments, a given frame 301 may or may not be prior art.

Continuing discussing FIG. 3A to FIG. 3E, in some embodiments, a given frame 301 may comprise a deck 303, a top 305, a sleeve-structure 307, an opening 309, a height-of-sleeve 311, an outside-diameter 313, an inside-diameter 315, and a bottom-surface 317. In some embodiments, deck 303 may be substantially flat planar surface of frame 301, that may be a largest such substantially flat planar surface of frame 301 and that may be most often be in a horizontal plane when frame 301 may be installed above a given ceiling (e.g. between two adjacent joists) (see e.g., FIG. 3A and/or FIG. 3C for deck 303). In some embodiments, top 305 may be a top (upper) surface of deck 303 (see e.g., FIG. 3A and/or FIG. 3C for top 305); whereas, bottom-surface 317 may be an opposing bottom (lower) surface of deck 303 (see e.g., FIG. 3D for bottom-surface 317). In some embodiments, top 305 and bottom-surface 317 may be opposing surfaces from each other (i.e., opposite sides/surfaces of deck 303). In some embodiments, sleeve-structure 307 may be an open (hollow) cylindrical member that descends downwards from top 305 (from deck 303) some fixed distance below (beneath) bottom-surface 317. At least portions of sleeve-structure 307 are shown in FIG. 3A to FIG. 3E. In some embodiments, sleeve-structure 307 may have two opposing terminal ends that are both open (e.g., at its top and its bottom), with opening 309 being the opening at a top of sleeve-structure 307. In some embodiments, opening 309 may be circular through opening (hole/aperture) in and/or through a thickness of deck 303. In some embodiments, opening 309 may define a top opening to (into) sleeve-structure 307. In some embodiments, height-of-sleeve 311, may be a height of sleeve-structure 307, i.e., may be the fixed distance that material of sleeve-structure 307 descends below bottom-surface 317 (at least a portion of height-of-sleeve 311 is called out in FIG. 3A and/or in FIG. 3E). In some embodiments, height-of-sleeve 311 may run from opening 309 to a bottom opening of sleeve-structure 307. In some embodiments, height-of-sleeve 311 may have a height that this typical for a thickness of a ceiling, such as, but not limited to, a thickness of drywall (or the like) that is configured for use in ceiling; e.g., height-of-sleeve 311 may have height of ⅝ of an inch or ½ of an inch (depending upon local codes). Note, in FIG. 3A to FIG. 3E, the bottom opening of sleeve-structure 307 is seated onto an upper portion of collar 100 (below its top 109). In some embodiments, outside-diameter 313, may be an outside diameter of sleeve-structure 307, see e.g., FIG. 3B for outside-diameter 313. In some embodiments, inside-diameter 315, may be an inside diameter of sleeve-structure 307, see e.g., FIG. 3A and/or FIG. 3E for inside-diameter 315. When a given light-module 401 may be attached to a given frame 301 (e.g., FIG. 4A), its light emitting portion may be located to be placed within sleeve-structure 307 and/or oriented to shine out of a bottom of sleeve-structure 307.

Continuing discussing FIG. 3A to FIG. 3E, in some embodiments, a given collar 100 may be configured to be removably attached to a given frame 301. In some embodiments, this removable attachment may be accomplished by the top-inside-diameter 139 of the given collar 100 (of top-cylindrical-portion 105) fitting around the inside-diameter 315 of at least a bottom portion of the sleeve-structure 307 of that given frame 301, but with a majority of the prongs 113 of that given collar 100 being located inside of that inside-diameter 315, aside from the prong-ends 117 portions which may reside above a top 305 of a deck 303 of that given frame 301. In some embodiments, when a given collar 100 may be attached to a given frame 301, at least a bottom portion of the sleeve-structure 307 may be located in between prongs 113 and top-inside-diameter 139, in gap 145 (see e.g., FIG. 1B for gap 145). In some embodiments, gap 145 may be configured to removably receive a thickness of sleeve-structure 307 therein. Recall, in some embodiments, no portion of a given prong 113 may physically touch top-cylindrical-portion 105, thus there may be a gap between a given prong 113 and the interior (inside) surface of top-cylindrical-portion 105 that is closest to that given prong 113 and that gap is a gap 145, as shown in FIG. 1B. Note, once at least a bottom portion of sleeve-structure 307 may be seated into gap 145 at each prong 113 of a given collar 100, the prong-ends 117 of those prongs 113 prevents that now attached collar 100 from becoming detached from that given frame 301. Detachment requires simultaneous squeezing of all prong-ends 117 towards each other (i.e., inwards towards common (shared) central axis 135) while also simultaneously pulling collar 100 away and downwards from bottom-surface 317. Whereas, attaching that given collar 100 to that given frame 301 merely requires pushing an upper end of that collar 100 upwards with its prong-ends 117 initially inside of sleeve-structure 307, and continuing that upward pushing until those prong-ends 117 pop out of opening 309 and onto top 305 of deck 303, proximate to opening 309. In some embodiments, once a given collar 100 may be (removably) attached to a given frame 301, because that given collar 100 extends below where sleeve-structure 307 ends (e.g., by height-of-bottom-portion 129), there is now additional descending structure (e.g., in the form of bottom-cylindrical-portion 103) to accommodate ceilings that are thicker than height-of-sleeve 311 (e.g., thicker than ⅝ of an inch) or wherein bottom-surface 317 (of frame 301) has to be mounted above a top of a given ceiling with some gap (more than ⅝ of an inch) between bottom-surface 317 and the top of that ceiling.

FIG. 4A depicts a system 400 (kit 400) of a given collar 100 (removably) installed into a frame 301, and with a light-module 401 attached to and/or in operative communication with that frame 301, shown from a top perspective view (of that collar 100, of that frame 301, and/or of that light-module 401). FIG. 4A is similar to FIG. 3A and/or to FIG. 3E, but in FIG. 4A a light-module 401 is also included. FIG. 4B depicts system 400 (kit 400) of a given collar 100 (removably) installed into that given frame 301, and with that light-module 401 attached to and/or in operative communication with that frame 301, shown from a bottom perspective view (of that collar 100, of that frame 301, and/or of that light-module 401). FIG. 4B is similar to FIG. 3D, but in FIG. 4B a light-module 401 is also included. FIG. 4C depicts system 400 (kit 400) with the given collar 100 (removably) installed into the frame 301, and with that light-module 401 attached to and/or in operative communication with that frame 301, shown from a front view of that collar 100 (side view of frame 301). FIG. 4C is similar to FIG. 3B, but in FIG. 4C a light-module 401 is also included. In some embodiments, system 400 (kit 400) may comprise one frame 301, one collar 100, and one light-module 401. In some embodiments, system 400 (kit 400) may comprise at least one frame 301, at least one collar 100, and at least one light-module 401. In some embodiments, system 400 (kit 400) may comprise one frame 301, one collar 100, one light-module 401, and one trim 407. In some embodiments, system 400 (kit 400) may comprise at least one frame 301, at least one collar 100, at least one light-module 401, and at least one trim 407. In some embodiments, light-module 401 may be a light fixture, a light source, a recessed light, and/or the like. In some embodiments, a given light-module 401 (of the present [instant] patent application) may be selected from at least one of: “integrated-lighting-module 100” from U.S. utility U.S. Pat. No. 10,914,465; “downlight 100” from U.S. utility U.S. Pat. No. 11,300,259; “integrated-lighting-module 100” from U.S. utility U.S. Pat. No. 12,066,175; “integrated-lighting-module 100” from U.S. patent application Ser. No. 17/959,579; “integrated-lighting-module 100,” “integrated-lighting-module 1800,” “integrated-lighting-module 1900,” and/or “integrated-lighting-module 2300,” all from U.S. patent application Ser. No. 19/020,672; a portion thereof; combinations thereof; and/or the like; wherein the contents, disclosures, and teachings of those patents and those patent applications are hereby incorporated by reference as if fully set forth herein. Note, in some embodiments, a given light-module 401 may or may not be prior art. In some embodiments, a given light-module 401 (of the present [instant] patent application) may be selected from at least one of the following light module products: Koto Modules, ELK0330, ELK0930, ELK10CT5, ELK1130, or ELK1330 (all of which are from AMP Plus, Inc. dba ELCO Lighting), wherein the contents, disclosures, and teachings of those light module products are hereby incorporated by reference as if fully set forth herein.

Continuing discussing FIG. 4A to FIG. 4C, in some embodiments, a given light-module 401 may comprise at least one heat-sink 403. In some embodiments, heat-sink 403 may be configured to emit and/or remove heat from at least some electronics of light-module 401. In some embodiments, heat-sink 403 may comprise at least one fin. In some embodiments, located within heat-sink 403 and/or below heat-sink 403 may be a light source (e.g., a LED (light emitting diode), with circuitry/PCB (and optionally a driver [transformer]). In some embodiments, located below heat-sink 403 may be an optical reflector (and optionally a lens). In some embodiments, optionally located above heat-sink 403 may be driver (transformer) within a housing 405. In some embodiments, light-module 401 may be without a driver (transformer) or a driver (transformer) may be onboard the PCB that controls the light-source (e.g., a LED). In some embodiments, light-module 401 may comprise attachment structure (attachment means) for (removable) attachment to a given frame 301. In some embodiments, light-module 401 may comprise attachment structure (attachment means), such as, but not limited to, “wing 453” (a spring structure) from U.S. Pat. No. 11,384,910 used for attaching a light module to other structures; clips; clamps; springs; bolts; screws; friction fits; snap fits; combinations thereof; and/or the like.

FIG. 4B and FIG. 4C also show a trim 407 member. In some embodiments, trim 407 may be a component of light-module 401 or trim 407 may be an accessory (or add-on) for a given light-module 401. In some embodiments, a bottom portion of trim 407 may comprise a flange 409. In some embodiments, it may be a bottom surface of flange 409 that is visible from an observer located below the ceiling where at least most of light-module 401 may be installed there above. In some embodiments, attachment of trim 407 to light-module 401 and/or attachment of trim 407 to frame 301, may be how that given light-module 401 gets trimmed out, from the perspective of the observer located below that ceiling and looking up at the ceiling and the recessed lighting installed therein. In some embodiments, flange 409 may be a flange on a bottom portion of trim 407. In some embodiments, flange 409 may a hollow annular disc (disk) shape. In some embodiments, above flange 409 trim 407 may have a hollow cylindrical shape to a hollow frustum shape. FIG. 4B may show at least a portion of an interior-sidewall 411, which may be an interior (inside) sidewall surface of trim 407, above its flange 409. In some embodiments, trim 407 may comprise flange 409, interior-sidewall 411, a hollow cylindrical shape above flange 409, or a hollow frustum shape above 409. Note, an exterior-sidewall portion of trim 407 is covered over by bottom-cylindrical-portion 103 of collar 100 in FIG. 4B and in FIG. 4C.

When light-module 401, trim 407, frame 301, and collar 100 are installed with respect to a given ceiling, the following would typically be hidden from view by that ceiling, with respect to an observer located below that ceiling: all of collar 100; all of frame 301; at least most of light-module 401; and at least some of trim 407 (e.g., its exterior-sidewall portion of trim 407 would be hidden).

When light-module 401, trim 407, frame 301, and collar 100 are installed with respect to a given ceiling, the following would typically be visible from below that ceiling, with respect to an observer located below that ceiling: the light emitting portion of light-module 401; an optical reflector of light-module 401; flange 409 (of trim 407); and interior-sidewall 411 (of trim 407).

Note, in FIG. 4C, a distance between bottom-surface 317 (of frame 301) and a top of flange 409, may how thick the ceiling may be, which is considerably thicker than height-of-sleeve 311 (of frame 301).

In some embodiments, light-module 401 may comprise at least one of: heat-sink 403; driver-housing 405; a light source; a LED; a PCB; a driver; electronics; optical reflector; a holder; the attachment structure (attachment means); trim (e.g., trim 407); flange (e.g., flange 409); structure to join such parts/components together; combinations thereof; and/or the like.

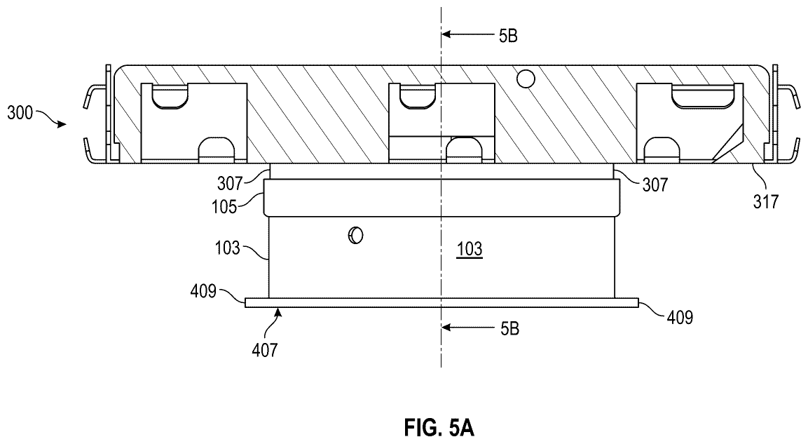

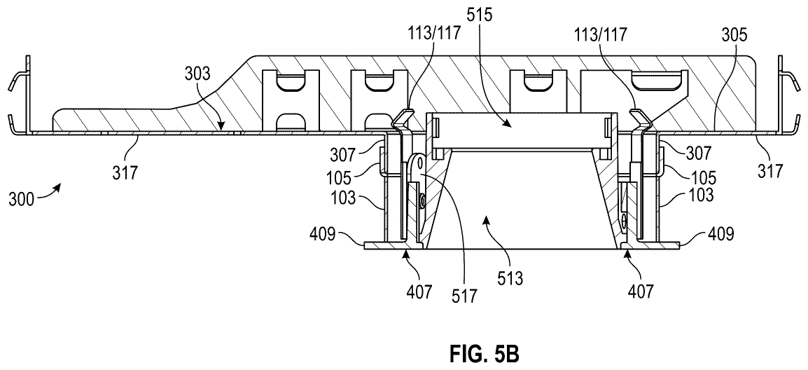

FIG. 5A is a front (or rear) view of frame 301, with an attached collar 100, including trim 407, but omitting at least upper portions of light-module 401 (such as, but not limited to, omitting heat-sink 403 and housing 405). FIG. 5A includes a sectional-line 5B-5B for generating FIG. 5B. FIG. 5A is similar to FIG. 4C, but rotated ninety (90) degrees and without including at least some upper portions of light-module 401.

FIG. 5B may be a cross-sectional view through at least a portion of a system 400 (kit 400) (and/or system 300 [kit 300]) along sectional-line 5B-5B, wherein sectional-line 5B-5B is depicted in FIG. 5A. However, at least some upper portions of light-module 401 (such as, heat-sink 403 and housing 405) are not included in FIG. 5B. This cross-sectional view also shows the conical frustrum of reflector 513 of trim 407; the cylindrical holder-of-light-module 515 of trim 407; and tension-clip(s) 517 of trim 407. In some embodiments, trim 407 may comprise reflector 513, holder-of-light-module 515, and at least one tension-clip 517. In some embodiments, holder-of-light-module 515 may be configured for (removable) attachment with light-module 401. In some embodiments, with respect to trim 407, interior-sidewall 411 and reflector 513 may be used interchangeably. In some embodiments, trim 407 may comprise interior-sidewall 411 and/or reflector 513. In some embodiments, a bottom portion of light-module 401 may be configured to twist-lock for removable attachment into holder-of-light-module 515 of trim 407 at a top/upper region of trim 407. In some embodiments, light-module 401 may sit and/or twists onto trim 407 at holder-of-light-module 515. In some embodiments, trim 407 may hold (attach) into collar 100 with the tension-clip(s) 517 (of trim 407) on sides of trim 407. So, in some embodiments, light-module 401 may not directly physically touch (contact) frame 301 and/or collar 100. In some embodiments, light-module 401 may only physically touch (contact) trim 407. In some embodiments, trim 407 may directly physically touch (contact) light-module 401 and collar 100.

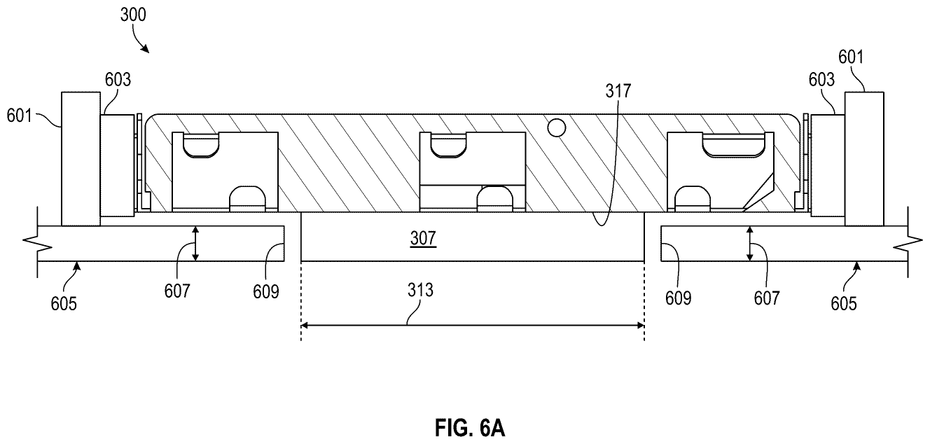

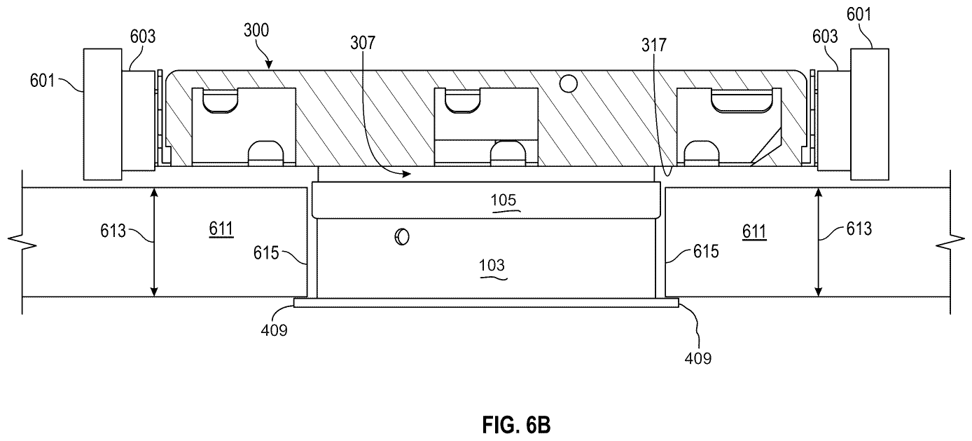

FIG. 6A shows a given frame 301 with a light-module 401 attached to and/or in operative communication with that frame 301, shown from a side view of that frame 301. FIG. 6A may be similar to FIG. 4C, except in FIG. 6A there is no collar 100 and at least portions of joists 601, hanger-bars 603, and ceiling 605 are shown. FIG. 6A may be prior art. FIG. 6A shows how a given frame 301 and its light-module 401 may be installed above a given ceiling 605. FIG. 6A shows the default and/or typical ceiling-thickness 607, which may be about a same height as height-of-sleeve 311. In some embodiments, ceiling-thickness 607 may be ½ inch thick or ⅝ inch thick (drywall or the like). FIG. 6A also shows hole-in-ceiling 609 in ceiling 605, which is where light emitted from light-module 401 may shine out of; and/or edges of hole-in-ceiling 609 may get covered over with trim 407/flange 409. In some embodiments, ceiling 605 may comprise ceiling-thickness 609 which may be a thickness of ceiling 605. In some embodiments, hole-in-ceiling 609 may also be how light-module 401 gets installed into frame 301.

FIG. 6B depicts system 400 (kit 400) with a given collar 100 (removably) installed into a given frame 301, and with a light-module 401 attached to and/or in operative communication with that frame 301, shown from a front view of that collar 100 (and/or a side view of frame 301). FIG. 6B may be similar to FIG. 6A, except in FIG. 6B collar 100 is (removably) attached to the frame 301 and the ceiling of FIG. 6B, ceiling 611, may be effectively thicker than ceiling-thickness 607 of FIG. 6A. FIG. 6B may be similar to FIG. 4C, except in FIG. 6B at least portions of joists 601, hanger-bars 603, and ceiling 605 are shown and at least a portion of the thicker 611 is shown. In some embodiments, ceiling 611 may be thicker than ceiling 605. In some embodiments, ceiling 611 may comprise ceiling-thickness 613 which may be a thickness of ceiling 611. In some embodiments, ceiling-thickness 613 may be thicker than ceiling-thickness 607. In some embodiments, ceiling-thickness 613 may be thicker than (greater than): ½ inch or ⅝ inch. FIG. 6B also shows hole-in-ceiling 615 in ceiling 611, which is where light emitted from light-module 401 may shine out of; and/or edges of hole-in-ceiling 615 may get covered over with trim 407/flange 409. In some embodiments, hole-in-ceiling 615 may also be how light-module 401 gets installed into frame 301. In some embodiments, embodiments, hole-in-ceiling 615 may be a through hole in ceiling 611. In some embodiments, hole-in-ceiling 615 may be cut into ceiling 611. In some embodiments, ceiling 611 may comprise hole-in-ceiling 615. In some embodiments, hole-in-ceiling 615 may be a same size as hole-in-ceiling 609; or at least (slightly) larger than top-outside-diameter 143 of collar 100 (i.e., hole-in-ceiling 615 may be larger than a largest outside diameter of collar 100). In some embodiments, ceiling 611 may be one or more layers, that in total have an overall (total) ceiling-thickness 613 of all those layer(s). In some embodiments, ceiling 611 may be made up from one or more layers of drywall, wood, plywood, tile, masonry product, siding, OSB, particle board, backer board, cement board, shiplap siding, rock, granite, porcelain, plastic, metal, sheet material, sheet goods, concrete, a portion thereof, combinations thereof, laminates thereof, composites thereof, and/or the like.

In some embodiments, a given extension-collar 100 may comprise: a single bottom-cylindrical-portion 103, a single top-cylindrical-portion 105, and two or more prongs 113. In some embodiments, bottom-cylindrical-portion 103 may comprise height-of-bottom-portion 129. In some embodiments, top-cylindrical-portion 105 may be integrally connected (fused and/or attached) with bottom-cylindrical-portion 103. In some embodiments, a top of bottom-cylindrical-portion 103 may transition into a bottom of top-cylindrical-portion 105. In some embodiments, top-cylindrical-portion 105 may comprise top-inside-diameter 139 and top-cylindrical-portion 105 may comprise height-of-top-portion 131. In some embodiments, at least portions (e.g., permanent-attachment-ends 119) of the two or more prongs 113 may be attached on inside-sidewall 111 of bottom-cylindrical-portion 103. See e.g., FIG. 1A to FIG. 1F. In some embodiments, extension-collar 100 may be configured to be (removably) attached to sleeve-structure 307 of frame 301, by the top-inside-diameter 139 fitting around an outside-diameter 313 of the sleeve-structure 307, by at least a portion of height-of-sleeve 311 of sleeve-structure 307 fitting inside of top-cylindrical-portion 105 up to height-of-top-portion 131, and by at least an upper portion (e.g., prong-end 117) of each of the two or more prongs 113 pushing against top 305 of deck 303 of frame 301 around opening 309 to sleeve-structure 307. See e.g., FIG. 3A, FIG. 3B, and FIG. 5B. In some embodiments, frame 301 may be configured to receive light-module 401. See e.g., FIG. 4A. In some embodiments, frame 301 may be configured to be installed above a ceiling 611. See e.g., FIG. 6B. In some embodiments, when extension-collar 100 may be (removably) attached to frame 301, the height-of-bottom-portion 129 may extend downwards past where the sleeve-structure 307 ends, and where a total height of extension-collar 100 may be fixedly sized to accommodate a thickness 613 of that ceiling 611. Compare FIG. 6B to FIG. 6A.

In some embodiments, extension-collar 100 may comprises gaps 145. In some embodiments, each gap 145, selected from the gaps 145, may be located in between a prong 113, selected from the two or more prongs 113, and an inside surface of the top-cylindrical-portion 103. In some embodiments, there may be one gap 145 per each prong 113 that is attached to bottom-cylindrical-portion 103 (specifically attached to inside-sidewall 111). See e.g., FIG. 1B and FIG. 5B. In some embodiments, these gaps 145 may be configured to fit at least a portion of the sleeve-structure 307 therein. See e.g., FIG. 5B.

In some embodiments, the two or prongs 113 do not physically touch the top-cylindrical-portion 105. See e.g., FIG. 1B and FIG. 5B. In some embodiments, an inside surface, an outside surface, and a top surface of the top-cylindrical-portion 105 may be are smooth and free of threads, fasteners, and/or holes. See e.g., FIG. 1A to FIG. 1F. In some embodiments, all around the top-cylindrical-portion 105, its height-of-top-portion 131 may be uniform, finite, fixed, and/or non-variable. See e.g., FIG. 1A to FIG. 1F.

In some embodiments, the height-of-top-portion 131 may be less than the height-of-bottom-portion 129. See e.g., FIG. 1A to FIG. 1F. In some embodiments, bottom-cylindrical-portion 103 may comprise bottom-hole 125. In some embodiments, top-cylindrical-portion comprises a top-hole 127. In some embodiments, bottom-hole 125 and top-hole 127 may be disposed opposite from each other. In some embodiments, bottom-hole 125 and top-hole 127 may be concentric with each other. In some embodiments, top-hole is larger than bottom-hole 125. See e.g., FIG. 1A to FIG. 1F. In some embodiments, extension-collar 100 may comprise transition 133. In some embodiments, transition 133 links (connects) bottom-cylindrical-portion 103 the top-cylindrical-portion 105. See e.g., FIG. 1A to FIG. 1F.

In some embodiments, an outside surface and a bottom surface of the bottom-cylindrical-portion 103 may be smooth and free of threads and/or fasteners. See e.g., FIG. 1A to FIG. 1F. In some embodiments, inside-sidewall 111 of bottom-cylindrical-portion 103 may be smooth and free of threads and/or fasteners, except where the at least portions (e.g., permanent-attachment-ends 119) of the two or more prongs 113 may be (fixedly and/or permanently) attached to inside-sidewall 111. See e.g., FIG. 1A and FIG. 1B. In some embodiments, all around the bottom-cylindrical-portion 103, its height-of-bottom-portion 129 may be uniform, finite, fixed, and/or non-variable. See e.g., FIG. 1A to FIG. 1F.

In some embodiments, each prong 113, selected from the two or more prongs 113, may be an elongate member with two opposing terminal ends, namely, a prong-end 117 and a permanent-attachment-end 119. See e.g., FIG. 1A to FIG. 1F; and/or see FIG. 2A to FIG. 2D. In some embodiments, permanent-attachment-end 119 may be fixedly attached to inside-sidewall 111 of bottom-cylindrical-portion 103. See e.g., FIG. 1A and FIG. 1B. In some embodiments, prong-end 117 may fixedly extend above top 109 of top-cylindrical-portion 105. See e.g., FIG. 1A to FIG. 1F. In some embodiments, when the extension-collar 100 may be (removably) attached to sleeve-structure 307, prong-end 117 may be the at least the upper portion of each of the two or more prongs 113 that pushes against top 305 of the deck 303 of the frame 301 around the opening 309 to the sleeve-structure 307. See e.g., FIG. 3A and FIG. 5B. In some embodiments, each prong 113, selected from the two or more prongs 113, may comprise prong-hole 121, such that there may be two or more prong-holes 121 per a given extension-collar 100. In some embodiments, bottom-cylindrical-portion 103 may comprise two or more sidewall-holes 123. In some embodiments, there may be a same quantity of sidewall-holes 123 as there are prong-holes 121 per a given extension-collar 100. See e.g., FIG. 1A to FIG. 1F. In some embodiments, each sidewall-hole 123, selected from the sidewall-holes 123, may be a location where a given prong 113, selected from the two or more prongs 113, may be fixedly attached to bottom-cylindrical-portion 103 (e.g., at inside-sidewall 111). See e.g., FIG. 1A and FIG. 2A to FIG. 2D. In some embodiments, each sidewall-hole 123, selected from the sidewall-holes 123, may be concentric with a given prong-hole 121 selected from the two or more prong-holes 121. See e.g., FIG. 1A.

In some embodiments, extension-collar 100 may be (removably) attachable to sleeve-structure 307 and frame 301 without using any tools that are separate, distinct, and/or external from that given extension-collar 100 and that given frame 301. In some embodiments, thickness 613 of ceiling 611 may be thicker than a single sheet of drywall.

In some embodiments, at least one of: prong-hole 121, sidewall-hole 123, bottom-hole 125, top-hole 127, hole-in-ceiling 609, and/or hole-in-ceiling 615 may be circular in shape (although at least some such holes need not have same dimensions as each other). In some embodiments, prong-hole 121 and sidewall-hole 123 that are closest to each other may be concentric with each other (and of same size with each other). In some embodiments, bottom-hole 125 and top-hole 127 may be concentric with each other (but different sizes from each other).

In some embodiments, a given collar 100 may be completely free of (devoid of) threads (threading) (as in the type of fastener), such as, but not limited to threading wrapping around bottom-cylindrical-portion 103 and/or around top-cylindrical-portion 105.

In some embodiments, collar 100, bottom-cylindrical-portion 103, top-cylindrical-portion 105, and/or prongs 113 may be made from one or more rigid material(s) of construction, such as, but not limited to, metal(s), alloy(s), and/or plastics.

An extension-clip-in-collar (collar) and systems and/or kits that may comprise an extension-clip-in-collar (collar) have has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An extension-collar comprises:
a bottom-cylindrical-portion that comprises a height-of-bottom-portion;
a top-cylindrical-portion that is integrally connected with the bottom-cylindrical-portion, wherein a top of the bottom-cylindrical-portion transitions into a bottom of the top-cylindrical-portion, wherein the top-cylindrical-portion comprises a top-inside-diameter and comprises a height-of-top-portion;
two or more prongs, wherein at least portions of the two or more prongs are attached on an inside-sidewall of the bottom-cylindrical-portion;
wherein the extension-collar is configured to be attached to a sleeve-structure of a frame, by the top-inside-diameter fitting around an outside-diameter of the sleeve-structure, by at least a portion of a height-of-sleeve of the sleeve-structure fitting inside of the top-cylindrical-portion up to the height-of-top-portion, and by at least an upper portion of each of the two or more prongs pushing against a top of a deck of the frame around an opening to the sleeve-structure;
wherein the frame is configured to receive a light-module, wherein the frame is configured to be installed above a ceiling;
wherein when the extension-collar is attached to the frame, the height-of-bottom-portion extends downwards past where the sleeve-structure ends, wherein a total height of the extension-collar is fixedly sized to accommodate a thickness of the ceiling.

2. The extension-collar according to claim 1, wherein the extension-collar further comprises gaps, wherein each gap, selected from the gaps, is located in between a prong selected from the two or more prongs, and an inside surface of the top-cylindrical-portion.

3. The extension-collar according to claim 2, wherein the gaps are configured to fit at least a portion of the sleeve-structure therein.

4. The extension-collar according to claim 1, wherein the two or prongs do not physically touch the top-cylindrical-portion.

5. The extension-collar according to claim 1, wherein an inside surface, an outside surface, and a top surface of the top-cylindrical-portion are smooth and free of threads, fasteners, and holes.

6. The extension-collar according to claim 1, wherein all around the top-cylindrical-portion the height-of-top-portion is uniform, finite, fixed, and non-variable.

7. The extension-collar according to claim 1, wherein the height-of-top-portion is less than the height-of-bottom-portion.

8. The extension-collar according to claim 1, wherein the bottom-cylindrical-portion comprises a bottom-hole; wherein the top-cylindrical-portion comprises a top-hole; wherein the bottom-hole and the top-hole are disposed opposite from each other; wherein the bottom-hole and the top-hole are concentric with each other; wherein the top-hole is larger than the bottom-hole.

9. The extension-collar according to claim 1, wherein the extension-collar comprises a transition, wherein the transition links the bottom-cylindrical-portion to the top-cylindrical-portion.

10. The extension-collar according to claim 1, wherein an outside surface and a bottom surface of the bottom-cylindrical-portion are smooth and free of threads and fasteners.

11. The extension-collar according to claim 1, wherein the inside-sidewall of the bottom-cylindrical-portion is smooth and free of threads and fasteners, except where the at least portions of the two or more prongs are attached to the inside-sidewall.

12. The extension-collar according to claim 1, wherein all around the bottom-cylindrical-portion the height-of-bottom-portion is uniform, finite, fixed, and non-variable.

13. The extension-collar according to claim 1, wherein each prong, selected from the two or more prongs, is an elongate member with two opposing terminal ends, namely, a prong-end and a permanent-attachment-end; wherein the permanent-attachment-end is fixedly attached to the inside-sidewall of the bottom-cylindrical-portion; wherein the prong-end fixedly extends above a top of the top-cylindrical-portion; wherein when the extension-collar is attached to the sleeve-structure, the prong-end is the at least the upper portion of each of the two or more prongs that pushes against the top of the deck of the frame around the opening to the sleeve-structure.

14. The extension-collar according to claim 1, wherein each prong, selected from the two or more prongs, comprises a prong-hole, such that there are two or more prong-holes; wherein the bottom-cylindrical-portion comprises two or more sidewall-holes; wherein there is a same quantity of sidewall-holes as there are prong-holes.

15. The extension-collar according to claim 14, wherein each sidewall-hole, selected from the sidewall-holes, is a location where a prong, selected from the two or more prongs, is fixedly attached to the bottom-cylindrical-portion.

16. The extension-collar according to claim 14, wherein each sidewall-hole, selected from the sidewall-holes, is concentric with a prong-hole selected from the two or more prong-holes.

17. The extension-collar according to claim 1, wherein the extension-collar is attachable to the frame without using any tools that are separate and distinct from the extension-collar and the frame.

18. The extension-collar according to claim 1, wherein the thickness of the ceiling is thicker than a single sheet of drywall.
